(19) United States
(12) Patent Application Publication
(10) Pub. No.: US 2026/0288117 A1
(43) Pub. Date: Sep. 24, 2026

(54) Method and Device for Producing a Workpiece from a Workpiece Blank

(71) Applicant: Carl Zeiss Digital Innovation GmbH, Dresden (DE)

(72) Inventor: Franz-Georg Ulmer, Vogtareuth (DE)

(21) Appl. No.: 19/570,730

(22) Filed: Mar. 18, 2026

(30) Foreign Application Priority Data
Mar. 18, 2025 (DE) 10 2025 110 450.6

(51) Int. Cl. G05B 19/418

(52) U.S. Cl. CPC G05B 19/41815; G05B 19/4183; G05B 19/41875; G05B 2219/50041

(57) ABSTRACT

A device for producing a workpiece has a workpiece receptacle for a workpiece blank and a machining tool. A machine controller generates a motor current, which drives the machining tool relative to the workpiece receptacle. A vibration sensor captures a time-resolved signal, which represents a vibration profile during machining of the workpiece blank at a first nominal machining position with respect to a vibration axis. A partial signal profile is determined on the basis of the vibration profile, which represents a direction component of the motor current along the vibration axis. An actual first machining position is determined using the partial signal profile. The workpiece blank is then machined at at least one second machining position on the basis of the actual first machining position.

### CROSS-REFERENCE TO RELATED APPLICATIONS

This application claims priority to German Application No. 10 2025 110 450.6 filed Mar. 18, 2025, the entire disclosure of which is incorporated by reference.

### FIELD

The present invention relates to a method and to a device for producing a workpiece from a workpiece blank using a workpiece machining machine that is controlled in automated fashion, in particular a machine tool with cutting.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In many industries, intensive efforts are being made to improve production performance and product quality. Product quality is often defined by whether the workpieces produced meet predefined workpiece specifications, in particular with regard to the shape, position and dimensions of defined workpiece features, surface roughness, structure and/or gloss level of a surface. Workpieces that do not meet the predefined specifications must either be reworked or discarded, which impairs production performance and efficiency. In order to monitor product quality, it is known to integrate one or more measuring instruments into the production plant and sometimes even directly into a workpiece machining machine, in particular a machine tool. However, it is difficult to adjust a production process in real time when product quality decreases because the acquisition and evaluation of measurement results on workpieces during production or shortly after production takes time and the time delay is often too long to efficiently use the measurement results for production control. In many measurement methods, the time to obtain a result is often much longer than the cycle times of the production or the period length of fluctuations in the production process.

Particular challenges arise when a complex workpiece is produced in a process chain with multiple machining steps that require the workpiece blank to be rechucked. In this case, rechucking means that the workpiece blank or the workpiece that has only been partially produced must be transferred from a first holder to a second holder and, if necessary, fixed therein. This is especially the case when a workpiece blank is to be machined from six sides (“all around”) with narrow tolerances. As a result of the rechucking, a clear reference between the workpiece surfaces machined in different chucking operations is generally lost.

In some cases, it is possible to integrate quality inspections into the production process, for example by measuring an area that has already been machined on a workpiece blank in the working area of the machining machine and in the receptacle that was used for the machining, before the partially machined workpiece blank is machined further. Measuring probes, such as those offered by companies such as Renishaw or Blum-Novotest, can be used in the working area of the machining machine. However, the machining process for such production-based measurements must be interrupted, which affects the machine's production performance.

Nevertheless, quality control in industrial manufacturing processes has been of great interest for years to achieve cost-efficient production and high product acceptance by customers. There are many concepts and approaches for establishing quality assurance processes in the industrial manufacturing of workpieces.

U.S. Pat. No. 10,180,667 B2, for example, discloses a measuring technique integrated in a manufacturing machine for measuring a produced workpiece in which the measurement results are interpreted by trained artificial intelligence (AI). The AI determines new target control data based on the measurement results.

The publication “Prozesskraftmessung mit spindelintegrierter Sensorik” (Process force measurement with spindle-integrated sensor system) by Christian Brecher, Hans-Martin Eckel, Marcel Fey and Felix Butz, DOI 10.3139/104.111982 ZWF 113 (2018) 10; pages 660-663 @ Carl Hanser Verlag GmbH & Co. KG, ISSN 0032-678X, describes that knowing the process force with which a workpiece blank is machined makes it possible to obtain detailed insights into the manufacturing process and the manufacturing system. The process power forms the basis for process optimization and monitoring of the manufacturing system. Process forces could be indirectly calculated by a relative displacement between the spindle shaft and the spindle housing. For this reason, a main spindle was equipped with contactless displacement sensors in the form of eddy-current sensors to determine the force on the tool in the main machine axes.

The integration of such displacement sensors into the spindle of a workpiece machining machine is quite expensive and existing workpiece machining machines cannot be easily retrofitted.

If a workpiece machining machine has to use a greater force when cutting a workpiece blank, a higher motor power is usually required and as a result a higher motor current is required. Motor power and motor current therefore correlate to the process force, but in isolation do not provide sufficient information density to determine the forces occurring during machining with the resolution and accuracy desirable for efficient and error-correcting machining.

### SUMMARY

Against this background, it is an object of the present invention to provide a method and a device that enable the production of workpieces of high quality, in particular with regard to the shape, position and dimensions of defined workpiece features, in an efficient manner. In particular, it is an object of the invention to provide a method and a device that enable efficient production of workpieces with narrow tolerances on workpiece sides that are spaced apart from one another and in particular face away from one another.

One aspect of the invention provides a method for producing a workpiece from a workpiece blank, which method comprises the following steps:
providing a workpiece machining machine comprising a workpiece receptacle configured to hold the workpiece blank, comprising a machining tool moveable relative to the workpiece receptacle, comprising a drive motor configured to move the machining tool relative to the workpiece receptacle on the basis of a supplied motor current, comprising a machine controller configured to generate the motor current, and comprising at least one vibration sensor that is configured to capture a time-resolved signal, which represents a vibration profile during machining of the workpiece blank,
receiving a data set representing nominal workpiece properties of the workpiece,
machining the workpiece blank using the machining tool at a first nominal machining position, wherein the machine controller generates the motor current on the basis of the data set,
capturing a first signal profile comprising a plurality of temporally consecutive instantaneous values during machining of the workpiece blank at the first nominal machining position, the instantaneous values representing an instantaneous motor current,
capturing a first present vibration profile along a first defined vibration axis during machining of the workpiece blank at the first nominal machining position using the at least one vibration sensor,
determining a partial second signal profile containing a plurality of temporally consecutive partial instantaneous values during machining of the workpiece blank at the first nominal machining position, the partial instantaneous values representing an effective direction component of the instantaneous motor current along the first defined vibration axis,
determining an actual first machining position using the partial second signal profile, and
machining the workpiece blank at at least one second machining position on the basis of the data set and on the basis of the actual first machining position.

Another aspect provides a device for producing a workpiece from a workpiece blank, comprising
a workpiece receptacle configured to hold the workpiece blank,
a machining tool moveable relative to the workpiece receptacle,
a drive motor configured to move the machining tool relative to the workpiece receptacle on the basis of a supplied motor current,
a machine controller configured to generate the motor current, and
at least one vibration sensor configured to capture a time-resolved signal, which represents a vibration profile during machining of the workpiece blank,
wherein the machine controller is further configured to perform the following method steps:
receiving a data set representing nominal workpiece properties of the workpiece,
generating the motor current on the basis of the data set for machining the workpiece blank using the machining tool at a first nominal machining position,
capturing a first signal profile having a plurality of temporally consecutive instantaneous values during machining of the workpiece blank at the first nominal machining position, the instantaneous values representing an instantaneous motor current,
capturing a first present vibration profile along a first defined vibration axis during machining of the workpiece blank at the first nominal machining position using the at least one vibration sensor,
determining a partial second signal profile containing a plurality of temporally consecutive partial instantaneous values during machining of the workpiece blank at the first nominal machining position, the partial instantaneous values representing an effective direction component of the motor current along the first defined vibration axis,
determining an actual first machining position using the partial second signal profile, and
machining the workpiece blank at at least one second machining position on the basis of the data set and on the basis of the actual first machining position.

According to yet another aspect, there is also provided a computer program having program code configured to carry out a method of the aforementioned type when the program code is executed on a machine controller of a corresponding device.

The data set may be a CAD data set, a CAM data set and/or a set of control commands for the machine controller. It defines and/or represents nominal workpiece data, in particular dimensional properties with regard to the shape, dimension and position of features that the workpiece to be manufactured should have. Features may include, for example, the diameter, depth and position of a hole, radii, distances and/or lengths of edges, etc. The industrial production of workpieces based on such a data set is common nowadays.

The machine controller may include a numerical controller (NC controller), as is known to those skilled in the art of machine tools that perform machining. The machine controller may alternatively or additionally include a programmable logic controller (PLC) and/or other programmable components or logic circuits including commercially available PCs, industrial PCs, microcontrollers, ASICs, FPGAs and/or processors and memories connected via communication networks. The machine controller may advantageously include one or more drive control units, which provide individual motor currents for driving electric motors on the basis of control commands of a control program executed on the machine controller.

On the one hand, the novel method and the novel device capture temporally consecutive instantaneous values of one or more individual motor currents or signal values that correlate to the motor currents. In some example embodiments, the temporally consecutive instantaneous values of respective current control circuits can be provided in the machine controller. The temporally consecutive instantaneous values represent a motor current profile and thus also correlate to a respective motor power.

In addition, the novel method and the novel device capture at least one vibration signal, i.e. a signal representative of a vibration along a vibration axis during the machining of the workpiece blank, in a time-resolved manner during the machining of a workpiece. The vibration axis is a spatial axis. It therefore represents a defined spatial direction. The time-resolved vibration signal represents a vibration profile during machining of a workpiece along this spatial direction.

At least one partial signal profile is determined on the basis of the signal profile and the vibration profile in such a way that the direction information of the vibration profile is assigned to a component of the signal profile. In other words, the signal profile is quantitatively divided into a partial signal profile that can be assigned to the vibration along the vibration axis and at least one other component that is not assigned to this vibration along the vibration axis. The partial signal profile and, therefore also the motor current, in a certain way have impressed on them spatial direction information, which corresponds to the spatial direction of the vibration. This makes it possible to analyze and/or model the machining of the workpiece in the defined spatial direction, taking into account the instantaneous motor current that is responsible for the movement of the machining tool relative to the workpiece, and/or a corresponding motor power. Based on this, for example, a process force with which the machining tool acts on the workpiece blank can be determined. Alternatively or additionally, the actual feed rate of the machining tool can be determined relative to the workpiece blank. Both variants make it possible to at least approximately determine the actual position machined on the workpiece.

The novel method and the novel device implement a virtual measuring technique in the sense that actual properties of the workpiece after machining are determined by means of the signal profile and the at least one vibration profile as early as during machining of the workpiece, and are thus “measured virtually”. Virtual measurement makes it possible to measure a partially machined workpiece in situ and in parallel with the process during the production process and to use workpiece properties known from previous machining operations. The machining tool practically also becomes a virtual measuring tool and the novel method and the novel device use the measured values obtained in this way during the ongoing production process to optimize the further machining of the workpiece blank on the basis thereof. A second machining position can therefore advantageously be selected on the basis of the actual first machining position obtained in the manner described, for example, by moving the machining tool to the second machining position using a modified control command.

The novel method and the novel device make it possible to manufacture a workpiece with very precisely arranged workpiece features. It is advantageously possible to avoid interrupting the production process, which was required in previous procedures to measure a partially machined workpiece in the working area of a machine. The novel method and the novel device enable a higher production performance when producing workpieces with narrow tolerated workpiece features. The object mentioned above is therefore completely achieved.

In a preferred refinement, a second present vibration profile along a second defined vibration axis, which is transverse to the first defined vibration axis, is captured during machining of the workpiece blank at the first nominal machining position, a further partial signal profile with a plurality of further partial instantaneous values is determined, wherein the further partial instantaneous values represent a direction component of the motor current along the second defined vibration axis, and wherein the actual first machining position is also determined using the further partial signal profile.

A third present vibration profile along a third defined vibration axis is preferably also captured, wherein the third vibration axis is transverse and, in particular, orthogonal to the first and second vibration axes. A third partial signal profile is preferably also determined and the actual first machining position is also determined using the partial third signal profile.

The refinements make it possible to more precisely determine the actual first machining position in multiple dimensions and thus even more precisely manufacture a workpiece in terms of dimensions, shape and position.

In another refinement, the at least one vibration sensor is a multi-axis sensor, which captures a plurality of present vibration profiles along a plurality of transverse vibration axes.

Alternatively, the at least one vibration sensor may include a plurality of single-axis sensors. The refinement enables very simple integration of the sensors for multi-axis process monitoring in a workpiece machining machine. Advantageously, existing machines can easily be retrofitted with this refinement. Another advantageous refinement includes at least one vibration sensor on the machining tool and at least one additional vibration sensor on the workpiece blank and/or the workpiece receptacle. This refinement has the advantage that a difference between the respective vibration signal profiles can be formed, preferably a respective difference in relation to each captured spatial axis. If the workpiece blank vibrates almost in the same way as the machining tool, this may indicate that the workpiece blank is not currently being machined, in particular nothing is being machined. If, on the other hand, the workpiece were virtually non-vibrating, all of the vibration energy could be attributed to the machining process, in particular to a material removal process.

In another refinement, the at least one vibration sensor includes at least one acceleration sensor.

This refinement enables a very cost-effective implementation, in particular for multi-axis process monitoring.

In another refinement, the first signal profile is captured at a first sampling rate, wherein the first present vibration profile is captured at a second sampling rate higher than the first sampling rate.

This refinement enables information enrichment in the process monitoring in a cost-effective manner, while the capabilities of the machine controller can advantageously be used for the capturing of the motor current.

In another refinement, the partial second signal profile is determined with a plurality of interpolation values between temporally consecutive partial instantaneous values, wherein at least one respective interpolation value from the plurality of interpolation values interpolates two consecutive partial instantaneous values on the basis of the first present vibration profile.

In this refinement, upsampling is carried out, i.e. a numerical increase in the sampling rate with which the signal profile is captured. The refinement enables a higher resolution and thus an even more precise determination of the actual first machining position. In particular, the effects of individual cutting edges of a machining tool can be determined particularly well with this refinement.

In another refinement, the workpiece machining machine has a spindle, which rotates the machining tool relative to the workpiece blank, wherein the motor current drives the spindle.

Alternatively or additionally, the motor current or another motor current can cause a translational movement of the machining tool relative to the workpiece blank. Capturing vibrations in the region of a motor spindle, which rotates the machining tool relative to the workpiece blank, enables particularly efficient quality control and production process optimization, since rotational movements occur very frequently in the machining of workpieces and because vibrations during rotational movements have a great effect.

In another refinement, the machining tool has multiple cutting edges, which engage with the workpiece blank during the machining of the workpiece blank, wherein a characteristic value is determined depending on the partial second signal profile, which characteristic value represents a potential discrepancy between the cutting edges, and wherein an error signal is generated on the basis of the characteristic value.

This refinement enables early identification of wear and/or damage to the machining tool and thus a determined decision for early replacement. Unnecessary tool changes on the basis of qualitative criteria alone, such as a number of operating hours, can advantageously be avoided.

In another refinement, the partial second signal profile is determined and/or the actual first machining position is determined using a pre-trained AI model.

In this refinement, data that have been acquired using one or preferably more production runs are advantageously available, wherein both vibration data and representative data relating to the respective motor currents have been acquired. The data preferably also include measurement results and/or characteristic values derived therefrom, which are representative of the product properties of the workpieces produced by the production runs. In particular, the measurement results and/or characteristic values derived therefrom may represent actual differences between a nominal machining position and an actual machining position. Such data can be used to train an AI model (artificial intelligence model), such as a neural network, and then can be used in an efficient manner to determine the actual first machining position on the basis of a present signal profile and at least one present vibration profile. The actual first machining position can be determined very quickly in the profile of a current production process in this way.

It will be appreciated that the aforementioned features and the features still to be explained below can be used not only in the respectively cited combination, but also in other combinations or alone, without departing from the scope of the present invention.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 shows a schematic illustration of an example embodiment of the device,

FIG. 2 shows a schematic illustration with an example profile of a motor current, three simultaneous vibration profiles and two partial motor current profiles determined therefrom,

FIG. 3a shows, for example, a displacement in the Y direction (in μm) as a function of a cutting position of a tool with four cutting edges, which has been captured by means of eddy current sensors,

FIG. 3b shows the data of a vibration sensor corresponding to FIG. 3a, and

FIG. 4 shows a flowchart illustrating an example embodiment of a method for producing a workpiece.

In the drawings, reference numbers may be reused to identify similar and/or identical elements.

### DETAILED DESCRIPTION

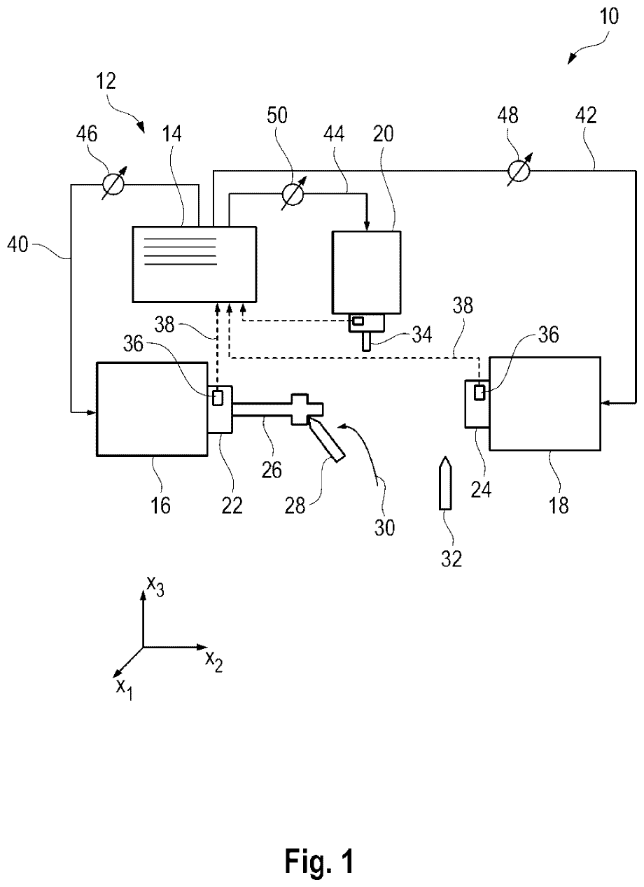

In FIG. 1, one example embodiment of the novel device is denoted in its entirety by the reference sign 10. In this example embodiment, the device 10 includes a workpiece machining machine 12 with three motor-driven spindles in a working area and a machine controller 14, which in this case controls all three spindles. In other example embodiments, the device 10 may include one or more separate workpiece machining machines, which are controlled individually or in a group by one or more machine controllers. Example embodiments of the device 10 preferably include at least one workpiece machining procedure.

The workpiece machining machine 12 is shown here as a multi-axis machine tool, which is able to handle various machining processes, such as cutting, milling, drilling, turning, grinding, etc. Examples of machine tools are commercially available from a variety of suppliers such as Nakamura, DMG Mori Seiki, Chiron, Heller and many others. In other example embodiments, the workpiece machining machine may only have one spindle, which is set up, for example, only for turning or only for milling and/or drilling of workpieces.

Workpiece machining machines have at least one movable machine element, the movement of which is controlled by the machine controller 14. In FIG. 1, the workpiece machining machine 12 by way of example has a first turning spindle 16, a second turning spindle 18, which is opposite the first turning spindle 16, and a drilling and milling spindle 20. The first turning spindle 16 has a first workpiece receptacle 22, typically in the form of a jaw chuck. The second turning spindle 18 has a second workpiece receptacle 24. A rod-shaped workpiece blank 26 is clamped here in the first workpiece receptacle 22. The turning spindle 16 includes a drive motor in a manner known per se and sets the rod 26 in a rotation around its longitudinal axis in a known manner. In this way, said turning spindle enables turning with a turning tool 28, which can be moved along a trajectory 30 relative to the workpiece receptacle 22 and the workpiece blank held there. In principle, the turning tool 28 can be manually entered into machining engagement with the workpiece blank 26. In preferred example embodiments, however, the turning tool 28 is controlled along the trajectory 30 by the machine controller 14 via one or more additional drive motors (not illustrated here). The workpiece blank 26 can also be machined using multiple different turning tools, for example with different cutting angles. In some example embodiments, the workpiece machining machine 12 may have a tool turret, which is equipped with a plurality of tools (not illustrated here).

The second turning spindle 18 enables turning of the workpiece blank 26 using an additional turning tool 32, in particular after the workpiece blank 26 has been rechucked from the first workpiece receptacle 22 into the second workpiece receptacle 24. The milling spindle 20 carries a drilling or milling tool 34 in a known manner and enables further machining on the workpiece blank 26. The further machining may include, in particular, separation of the partially machined workpiece blank 26 from the rest of the rod and/or a drilling and/or milling process when the workpiece blank is stationary. Alternatively or additionally, in additional example embodiments, a workpiece blank may be held in a fixed chuck on a workpiece table (not illustrated here) while it is machined using a machining tool.

In the example embodiment according to FIG. 1, sensors 36 are arranged in the region of each spindle. In principle, the sensors may also be arranged at other points in the working area of the workpiece machining machine 12, for example in the region of the tools 28, 32, 34. The sensors in this case each provide a time-resolved signal 38, which represents a vibration profile during the machining of the workpiece blank 26. The sensor signals 38 are fed to the machine controller 14. In some preferred example embodiments, the sensors 36 include one or more acceleration sensors, which each capture an acceleration along a defined sensor axis xi. In particularly preferred example embodiments, the sensors 36 each include a triaxial acceleration sensor, which provides corresponding acceleration signals with respect to three orthogonally adjacent signal axes x1, x2, x3. The acceleration signals represent, in particular, a vibration during machining of the workpiece blank along the respective signal axis (vibration axis) x1, x2, x3.

To machine the workpiece blank 26, the machine controller 14 generates in a manner known per se one or more currents, which are supplied in this example embodiment as motor currents 40, 42, 44 to the drive motors in the spindles 16, 18, 20 and optionally additional drive motors (not illustrated). Typically, the higher the respective motor current, the higher the torque and/or (depending on the load) the rotational speed or linear velocity that the drive motor transfers to the workpiece blank 26 and/or to the machining tool 28, 32, 34. As experts in this field are aware, the machine controller 14 may have one or more control loops using which the respective instantaneous value of the respective drive current is individually adjusted on the basis of a control program. Each control loop advantageously comprises at least one sensor 46, 48, 50, using which the present instantaneous values of the respective motor current 40, 42, 46 can be captured in a time-resolved manner in order to obtain a respective present motor current profile in this manner.

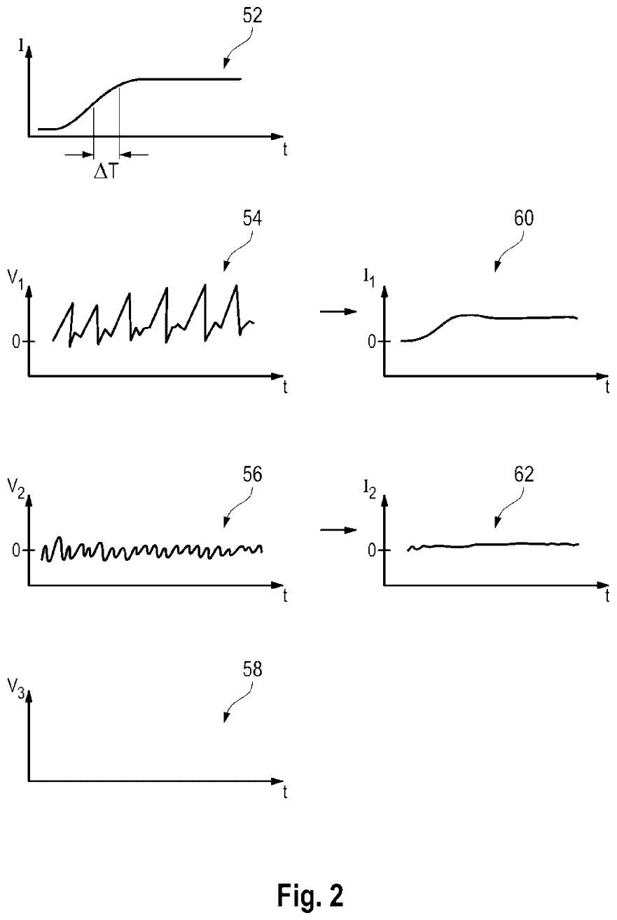

FIG. 2 shows a schematic illustration of an example motor current profile 52, thus a first signal profile. The time t is plotted on the abscissa and the motor current I is plotted on the ordinate here. In preferred example embodiments, instantaneous values of the motor current I (t) are captured at a sampling rate (illustrated here with reference to a schematically indicated sampling interval ΔT), which corresponds to the sampling rate at which the control loops of the machine controller 14 operate. In other words, in preferred example embodiments, the signal profile 52 can be detected using the control loops in the controller and advantageously without additional current meters.

In some preferred example embodiments, the respective machining position is set and controlled via stepper motors. Each stepper motor included a discrete counter that can be used to capture in high resolution and set an instantaneous motor position. Position control causes the motor to rotate to a specific position. The motor current required for this is measured. However, position uncertainty results from bending and/or dynamics of the motor shaft and the tool. Based on the signal profile 52 alone, an actual machining position on the workpiece blank 26 can therefore only be estimated with a relatively high degree of uncertainty. This is especially true if the machining tool has multiple cutting edges, which is often the case with milling heads, for example.

Below the signal profile 52, FIG. 2 schematically illustrates three example vibration profiles 54, 56, 58, which are simultaneously connected to the signal profile 52 during machining of the workpiece blank and have been captured in relation to three transverse and in particular orthogonal vibration axes x1, x2, x3. By way of example, the vibration profile 54 in this case shows a relatively strong vibration along the first vibration axis x1 with clearly measurable periodic fluctuations. For example, the fluctuations may be the result of an interaction between feed rate and the engagement of a cutting edge. The vibration profile 56 shows by way of example a low, but still measurable, vibration along the second vibration axis x2. The vibration profile 58 shows by way of example a barely measurable or non-measurable vibration along the third vibration axis x3.

According to one aspect of the novel method, partial signal profiles 60, 62 are determined on the basis of the signal profile 52 and on the basis of the vibration profiles 54, 56, 58. The respective instantaneous values of the partial signal profiles 60, 62 add up at each time t to the respective instantaneous value of the signal profile 52:

$$‖ ( {P}_{1} ( t ) , {P}_{2} ( t ) , {P}_{3} ( t ) ) ‖ = {P}_{Toral} ( t )$$

From a mathematical point of view, a total power Ptotal(t) is divided into multiple partial power profiles, wherein the law of conservation of energy is observed (amplitude equation). Since the power correlates to the motor current recorded in each case, the amplitude equation is given here in relation to the motor power.

Since the vibration with respect to the third vibration axis x3 in this example case is practically zero, only two partial signal profiles 60, 62 with respective instantaneous values not equal to zero are obtained here. The same applies, of course, if the vibrations are only determined in relation to two vibration axes in the first place. In some example embodiments, vibrations may be detected with respect to a plurality of axes including one or more translational axes and/or one or more rotational axes. The signal profile 52 in these example embodiments can advantageously be divided into a corresponding plurality of partial motor current profiles or corresponding partial power profiles.

The partial signal profiles advantageously represent a respectively effective direction component of the total motor current or the total power with respect to the respective vibration axes. In other words, the signal profile 52 is in this case divided into partial direction-dependent signal profiles 60, 62 using the vibration profiles 54, 56, 58. This advantageously makes it possible to determine a process force occurring during the machining of the workpiece blank depending on the direction, even if the movement of the machining tool relative to the workpiece blank is generated with a total motor current, which carries no direction information with respect to the machining of the workpiece blank.

The division of the total motor current can advantageously be based on the following relationship:

$${\int }_{{T}_{1}}^{{T}_{2}} \int {a}_{i} dt ∼ {P}_{i} ( {T}_{2} ) - {P}_{i} ( {T}_{1} )$$

A twofold integration of the acceleration ai in an axis direction i between a first time T1 and a second time T2 is largely proportional to the difference in the direction-related power P at the times T1 and T2 (direction relation). The amplitude equation primarily ensures the long-wave accuracy of the approximation, while the direction equation allows subsampling (dt). In other words, the direction relation provides supporting points for high-frequency interpolation of the enriched signals. In some preferred example embodiments, the vibration profiles with respect to the vibration axes can be captured at a higher sampling rate than the signal profile. This means that more supporting points are available for determining the partial signal profiles than the overall signal profile offers. The partial signal profiles can therefore advantageously be determined with a higher number of respective instantaneous values than the number of the captured instantaneous values of the overall signal profile.

If the underlying mathematical problem cannot be solved unambiguously, Occam's razor (principle of parsimony) can be used to find a solution. Here, for example, parsimonious (and thus simple) solutions are sought.

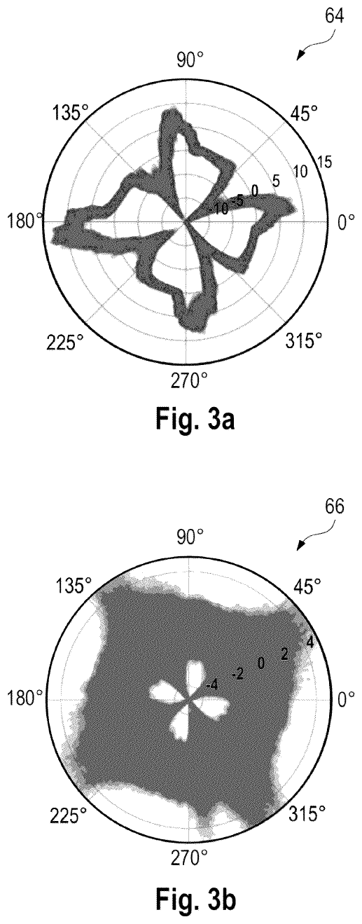

FIG. 3a shows, for example, a displacement 64 in the Y direction depending on the cutting edge position of a rotating tool with four cutting edges. In this case, the displacement 64 was captured using eddy-current sensors. FIG. 3b shows corresponding data 66, which were acquired by means of a vibration sensor. By integrating the acceleration values from FIG. 3b twice, the displacement 64 from FIG. 3a can be determined. Measurement errors are also integrated. This is why the motor power P is advantageously taken into account. The motor power and thus the motor current correlate to the machining force, which in turn correlates to the significance of the displacement (deviation from the turning center). The respective instantaneous amplitude of the displacement can therefore be advantageously determined from the instantaneous power and the respective instantaneous direction of the displacement can be determined from the vibration data. Thus, there is a direction relation and an amplitude equation.

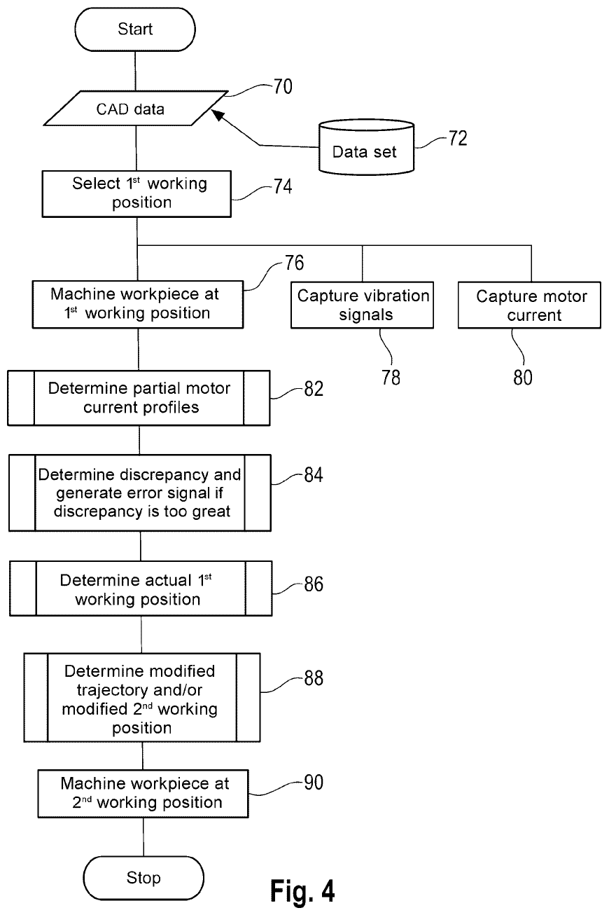

FIG. 4 shows an example embodiment of the method for producing a workpiece. In accordance with step 70, a data set 72 is first obtained here, which represents the desired workpiece properties of a new workpiece to be produced. This may be a CAD data set, a CAM data set or a data set with control commands for the machine controller 14, for example a data set with control commands in the form of M codes and/or G codes. Based on the data set, a first nominal machining position on a workpiece blank is selected in accordance with step 74. In preferred example embodiments, the first machining position has a very narrow tolerance to an additional machining position on the workpiece blank. The workpiece blank is then machined using a tool at the first machining position in accordance with step 76. Simultaneously, according to step 78, vibration signals with respect to one or more vibration axes and, according to step 80, the motor current with which the machining tool is moved relative to the workpiece blank are captured in a time-resolved manner. The motor current is advantageously captured at a first sampling rate corresponding to the sampling rate in the control loop of the machine controller. The vibration signals are preferably captured at a second sampling rate higher than the first sampling rate in the control loop of the machine controller.

Based on the vibration signals captured in step 78 and the motor current captured in step 80, partial motor current profiles are determined in the manner described above in accordance with step 82. In some example embodiments, a corresponding partial signal profile is determined for each vibration axis for which a vibration signal has been captured.

A process force acting in the respective direction of vibration can advantageously be determined in some example embodiments on the basis of the partial motor current profiles, as is indicated in the publication by Brecher, Eckel, Fey and Butz mentioned at the outset. In accordance with step 84, in some example embodiments in which the machining tool has multiple cutting edges, using the partial motor current profiles and/or using the direction-related process forces, it is possible to determine a characteristic value that is representative of any discrepancy in the machining of the workpiece blank with the various cutting edges. If the discrepancy should be too large, which may be due, for example, to a damaged cutting edge, an error signal is generated in the preferred example embodiments, which signals a machine operator to check and, if necessary, to replace the machining tool.

In step 86, an actual first machining position is determined on the basis of the partial motor current profiles and, if necessary, on the basis of the process forces determined in the respective vibration direction. The actual first machining position may deviate from the previously selected nominal machining position, for example due to wear of the machining tool, due to environmental influences and/or due to individual material properties of the workpiece blank.

In step 88, a modified trajectory and/or a modified second machining position is determined on the basis of the actual first machining position. The modified trajectory and/or modified second machining position may differ from a nominal trajectory and/or nominal second machining position. The nominal trajectory and/or nominal second machining position usually result from the data set 72. The modified trajectory and/or modified second machining position are advantageously adapted to the actual first machining position. This is particularly advantageous when the nominal first and the nominal second machining positions are defined with narrow tolerances relative to each other. The modified trajectory and/or modified second machining position advantageously contribute to the fact that the tolerances with respect to the actual first machining position can be observed. In accordance with step 90, the workpiece blank is then machined at the modified second machining position and/or with the modified trajectory at the second machining position.

In the preferred example embodiments, the method and the device allow upsampling of the sampling rate with which instantaneous values of the motor current are available in a conventional machine controller to better resolve the effects of individual cutting edges and, in addition, a dimensional enrichment in relation to individual spatial directions. For example, a 1D (non-directional) motor current time series becomes a 3D displacement time series using a triaxial acceleration sensor. This dimensionality is only an example here and can be further increased using appropriate hardware, in particular to three rotational and/or three translational degrees of freedom.

It is understood that the described method can be extended to a large number of first and second machining positions on a workpiece blank, so that the workpiece ultimately manufactured meets the desired specifications to a high degree.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD or DVD). The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR. The phrase “A, B, and/or C” should be construed in the same way as the phrase “at least one of A, B, and C.”

1. A method for producing a workpiece from a workpiece blank, the method comprising:
providing a workpiece machining machine including:
a workpiece receptacle configured to hold the workpiece blank,
a machining tool moveable relative to the workpiece receptacle,
a drive motor configured to move the machining tool relative to the workpiece receptacle based on a supplied motor current,
a machine controller configured to generate the supplied motor current, and
a set of vibration sensors that is configured to capture a time-resolved signal, which represents a vibration profile during machining of the workpiece blank;
receiving a data set representing nominal workpiece properties of the workpiece;
machining the workpiece blank using the machining tool at a first nominal machining position, wherein the machine controller generates the supplied motor current based on the data set;
capturing a first signal profile including a plurality of temporally consecutive instantaneous values during machining of the workpiece blank at the first nominal machining position, wherein the plurality of temporally consecutive instantaneous values represent an instantaneous motor current;
capturing a first present vibration profile along a first defined vibration axis during machining of the workpiece blank at the first nominal machining position using the set of vibration sensors;
determining a partial second signal profile containing a plurality of temporally consecutive partial instantaneous values during machining of the workpiece blank at the first nominal machining position, wherein the plurality of temporally consecutive partial instantaneous values represent an effective direction component of the instantaneous motor current along the first defined vibration axis;
determining an actual first machining position using the partial second signal profile; and
machining the workpiece blank at at least one second machining position based on the data set and the actual first machining position.

2. The method of claim 1, wherein:
a second present vibration profile along a second defined vibration axis is captured during machining of the workpiece blank at the first nominal machining position, the second defined vibration axis being transverse to the first defined vibration axis,
a further partial signal profile having a plurality of further partial instantaneous values is determined, wherein the plurality of further partial instantaneous values represent an effective direction component of the supplied motor current along the second defined vibration axis, and
the actual first machining position is also determined using the further partial signal profile.

3. The method of claim 1, wherein the set of vibration sensors is at least one multi-axis sensor that captures a plurality of present vibration profiles along a plurality of transverse vibration axes.

4. The method of claim 1, wherein the set of vibration sensors includes at least one vibration sensor on the machining tool and at least one additional vibration sensor on at least one of the workpiece blank or the workpiece receptacle.

5. The method of claim 1, wherein the set of vibration sensors includes at least one acceleration sensor.

6. The method of claim 1, wherein:
the first signal profile is captured at a first sampling rate, and
the first present vibration profile is captured at a second sampling rate higher than the first sampling rate.

7. The method of claim 1, wherein:
the partial second signal profile is determined with a plurality of interpolation values between the plurality of temporally consecutive partial instantaneous values, and
at least one respective interpolation value from the plurality of interpolation values respectively interpolates two consecutive partial instantaneous values based on the first present vibration profile.

8. The method of claim 1, wherein:
the workpiece machining machine has a spindle, which rotates the machining tool relative to the workpiece blank, and
the supplied motor current drives the spindle.

9. The method of claim 1, wherein:
the machining tool has multiple cutting edges, which engage with the workpiece blank during the machining of the workpiece blank,
a characteristic value is determined based on the partial second signal profile, which characteristic value represents a potential discrepancy between the multiple cutting edges, and
an error signal is generated based on the characteristic value.

10. The method of claim 1, wherein at least one of the partial second signal profile or the actual first machining position is determined using a pre-trained AI model.

11. A device for producing a workpiece from a workpiece blank, the device comprising:
a workpiece receptacle configured to hold the workpiece blank;
a machining tool moveable relative to the workpiece receptacle;
a drive motor configured to move the machining tool relative to the workpiece receptacle based on a supplied motor current;
a machine controller configured to generate the supplied motor current; and
a set of vibration sensors configured to capture a time-resolved signal, which represents a vibration profile during machining of the workpiece blank,
wherein the machine controller is configured to perform:
receiving a data set representing nominal workpiece properties of the workpiece,
generating, based on the data set, the supplied motor current to machine the workpiece blank using the machining tool at a first nominal machining position,
capturing a first signal profile having a plurality of temporally consecutive instantaneous values during machining of the workpiece blank at the first nominal machining position, wherein the plurality of temporally consecutive instantaneous values represent an instantaneous motor current,
capturing a first present vibration profile along a first defined vibration axis during machining of the workpiece blank at the first nominal machining position using the set of vibration sensors,
determining a partial second signal profile containing a plurality of temporally consecutive partial instantaneous values during machining of the workpiece blank at the first nominal machining position, wherein the plurality of temporally consecutive partial instantaneous values represent an effective direction component of the supplied motor current along the first defined vibration axis,
determining an actual first machining position using the partial second signal profile, and
machining the workpiece blank at at least one second machining position based on the data set and the actual first machining position.

12. A non-transitory computer-readable medium comprising program code configured to be loaded into a machine controller of a device configured to produce a workpiece from a workpiece blank, wherein:
the device includes:
a workpiece receptacle configured to hold the workpiece blank,
a machining tool moveable relative to the workpiece receptacle,
a drive motor configured to move the machining tool relative to the workpiece receptacle based on a supplied motor current, and
a set of vibration sensors configured to capture a time-resolved signal that represents a vibration profile during machining of the workpiece blank; and
the program code is configured to perform:
receiving a data set representing nominal workpiece properties of the workpiece,
machining the workpiece blank using the machining tool at a first nominal machining position, including controlling the machine controller to generate the supplied motor current based on the data set,
capturing a first signal profile including a plurality of temporally consecutive instantaneous values during machining of the workpiece blank at the first nominal machining position, wherein the plurality of temporally consecutive instantaneous values represent an instantaneous motor current,
capturing a first present vibration profile along a first defined vibration axis during machining of the workpiece blank at the first nominal machining position using the set of vibration sensors,
determining a partial second signal profile including a plurality of temporally consecutive partial instantaneous values during machining of the workpiece blank at the first nominal machining position, wherein the plurality of temporally consecutive partial instantaneous values represent an effective direction component of the instantaneous motor current along the first defined vibration axis,
determining an actual first machining position using the partial second signal profile, and
machining the workpiece blank at at least one second machining position based on the data set and the actual first machining position.
